(19) United States
(12) Patent Application Publication
(10) Pub. No.: US 2010/0107240 A1
(43) Pub. Date: Apr. 29, 2010

(54) NETWORK LOCATION DETERMINATION FOR DIRECT ACCESS NETWORKS

(75) Inventors: David Thaler, Redmond, WA (US); Rob M. Trace, Redmond, WA (US); Deon C. Brewis, Redmond, WA (US); Arun K. Buduri, Seattle, WA (US); Bill Begorre, Redmond, WA (US); Scott Roberts, Redmond, WA (US); Srinivas Raghu Gatta, Redmond, WA (US); Gerardo Diaz Cuellar, Kirkland, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 12/357,812

(22) Filed: Jan. 22, 2009

Related U.S. Application Data
(60) Provisional application No. 61/108,472, filed on Oct. 24, 2008.

(51) Int. Cl. G06F 21/00

(52) U.S. Cl. 726/15

(57) ABSTRACT

A client computer that supports different behaviors when connected to a private network behind a network firewall than when outside the network firewall and connected indirectly through an access device. The client computer is configured to attempt communication with a device on the network. Based on the response, the client computer can determine that it is behind the network firewall, and therefore can operate with less restrictive security or settings for other parameters appropriate for when the client is directly connected to the network. Alternatively, the client computer may determine that it is indirectly connected to the network through the Internet or other outside network, and therefore, because it is outside the private network firewall, should operate with more restrictive security or settings of other parameters more appropriate for use in that network location. The described approach operates even if the remote client computer has a direct connection to the network that enables it to authenticate with a domain controller.

### BACKGROUND

Computer networks are widely used by companies because they streamline business processes by enabling sharing of information at many locations. In many instances, companies provide network access to their employees and other authorized parties, even when those parties are at locations remote from the company's premises.

A corporate network may be configured to limit access to network resources to only authorized parties by using one or more domain controllers, which are sometimes called Active Directory servers. A domain controller may authenticate users to identify those that should be granted network access. In some instances, there may be multiple domain controllers. To map devices connected to the network to a nearby domain controller, each domain controller may have a table that identifies ranges of source network addresses. When a domain controller receives a request from a device, it may respond by identifying for the device a domain controller near the device.

Remote access to a corporate network may be provided through a virtual private network (VPN). With a VPN, a computer operated by an authorized user establishes a tunnel to the corporate network through a VPN gateway server over a public network to which the remote computer can connect. Because computers connected through a VPN tunnel comprise a portion of the corporate network, the computer can then use resources on the corporate network.

In many companies that allow remote access to their corporate networks, portable computers are used for network access. The portable computers can be used on company premises where they can be connected physically to the corporate network. At other times, the portable computers may be brought to remote locations where they are logically connected to the network through a VPN. To provide ease of use, such computers may be configured to have two different groups of settings: one appropriate for use on a private company network and another appropriate for use when the computer is connected to a public network over which a VPN tunnel can be established. These settings may affect operations of the portable computer, such as the default printer, a home page, a time zone setting for a clock or security functions. For example, the security setting used when the portable computer is directly connected to the network may rely on the firewall or other protective components of the corporate network and therefore be less restrictive. When the portable computer is connected to the corporate network via a VPN, a more restrictive security configuration may be applied.

To determine the appropriate group of settings, the portable computer may include a network location awareness component that can indicate the type of connection the computer has to the network. Conventionally, the network location has been ascertained by attempting to authenticate against a domain controller on the network. If the portable computer can authenticate with a domain controller, the computer may be configured with settings appropriate for devices directly connected to the corporate network. If authentication is not possible, different settings may be used.

In another context, some computers display an indication of whether the computer has connectivity to the Internet. A computer can determine its connection status by attempting to contact a known server on the Internet. If the computer receives a response from the server, the computer infers that it has connectivity to the Internet and displays an indication accordingly.

### SUMMARY

The inventors have recognized and appreciated that direct access to a private network by remote computers may soon be widespread. When remote access is possible without the use of a VPN, remote devices will be able to authenticate against domain controllers on the private network.

The inventors have further recognized and appreciated that direct access will alter the operation of network location awareness components that rely on the ability or inability to authenticate against a domain controller as a secure indication of network location. When the indication of network location is determined simply by the ability to authenticate with a domain controller, the case in which a remote device is connecting to a network without the use of a VPN will be indistinguishable from that of a client physically connected to the network or connecting to the network via a VPN connection. Yet, users or computer administrators may not expect or want the remote computer to have the same settings in these different scenarios.

To maintain appropriate settings, a private network may be configured with one or more devices that make different responses to requests from client devices, depending on a portion of the network address of the client device. A first response may be made when the request is received from a client device with a network address indicating that the client device is physically connected to the network within the network firewall. A second, different, response may be made when the request is received from a client device with a network address indicating that the client device is a remote device not connected to the network within the network firewall. And, possibly a third response may be made when the request is received from a remote client device connected within the network firewall through the use of VPN. Though, in this third scenario, the network alternatively may be configured, according to some embodiments, to generate the first response. In yet other embodiments, in the third scenario, the network alternatively may be configured to generate the second response. Regardless of the specific configuration, based on the nature of the response received by the client device, the client device may select an appropriate configuration.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is an illustration of a conventional computing device, illustrating an environment in which network location determination may be performed;

FIG. 2 is a sketch of a conventional network environment in which direct access is provided to a private network;

FIG. 3 is a sketch of a private network configured to provide responses useful for network location determination;

FIG. 4 is a sketch of an alternative embodiment of a private network configured to provide information useful for network location determination;

FIG. 5 is a sketch of an alternative embodiment of a private network configured to provide information useful for network location determination;

FIG. 6 is a sketch of an alternative embodiment of a private network configured to provide information useful for network location determination; and

FIG. 7 is a flow chart of a method of operation of a network client and a network device configured to perform network location determination.

### DETAILED DESCRIPTION

For computers that are configured to access a corporate, enterprise or other private network, improved network location awareness can be provided by configuring the computer to attempt to communicate with a device on the network. By configuring that device to respond differently to devices depending on the nature of the connection to the network, the computer can gain useful information about its own location based on the response. For example, computers that are connected to the private network through a physical connection or a VPN may experience a different response than devices that are outside the private network, but connected to the private network through a remote access mechanism that involves a public network such as the Internet.

This information will be accurate even if direct network access is available and allows the computer to authenticate against a domain controller on the private network in a fashion that would cause some conventional network location determination approaches to incorrectly indicate that the computer is directly connected to the private network. Better security is provided for the computer when this location information is used to select an appropriate security configuration. For example, the computer may be configured to operate in different security states, one of which is appropriate for use when the computer is physically connected to the private network on company premises and therefore behind a firewall. Another security state may be appropriate for scenarios in which the computer is virtually connected to the private network through a secure VPN tunnel. Yet another scenario may apply in which the computer is not directly on the private network, either physically or virtually via a VPN tunnel, and therefore not protected by a firewall for the private network. Such security states may be implemented in any suitable way. In some instances, the security states are implemented by a firewall on the computer that supports different configurations. When not directly connected to the network, the firewall may have a more restrictive configuration. In contrast, when the computer is directly connected to the network, a less restrictive firewall configuration may be provided. Similarly, when other settings are selected based on computer location, more accurately determining location can lead to automated selection of those settings to provide a more desirable user experience.

Any of a number of approaches is suitable for configuring a device or devices to generate a different response based on the location of the computer that issued a request prompting the response. In some embodiments, the particular arrival interface of a network packet may be used to identify the location of the computer. In other embodiments, information in a header of a network packet may be used to identify the location of the computer. For example, a network address in a packet header containing the request or the response may allow a network device to determine whether the computer issuing the request is physically on the network, if the device has some way to know that the network address was not spoofed. As a specific example, a network prefix portion of the address may indicate the location of the computer once the computer has shown that it can receive packets destined to that address by being able to successfully establish a TCP connection.

Any suitable device or devices processing such packets may be configured to respond differently based on whether such packets have a network prefix indicating that they have been received from or are destined to either a device behind the network firewall or outside the network firewall. In some embodiments, the request may be directed to a server on the network. The server may be programmed to make a different response depending on the location of the computer issuing the request, such as is the case with domain controllers today. In other embodiments, one or more intermediate devices that would process a packet to or from a server replying to a request may behave differently depending on the location of the computer issuing the request. For example, an intermediate device, such as a firewall, may selectively block packets containing the request or the reply based on the network prefix associated with the computer that issued the request in the headers of those packets.

From the foregoing overview of some embodiments, one of skill in the art can appreciate that embodiments may be constructed based on programming of one or more computer devices. Prior to providing a more detailed description of the structure and operation of exemplary embodiments, an overview of components that may exist in a computing device is provided.

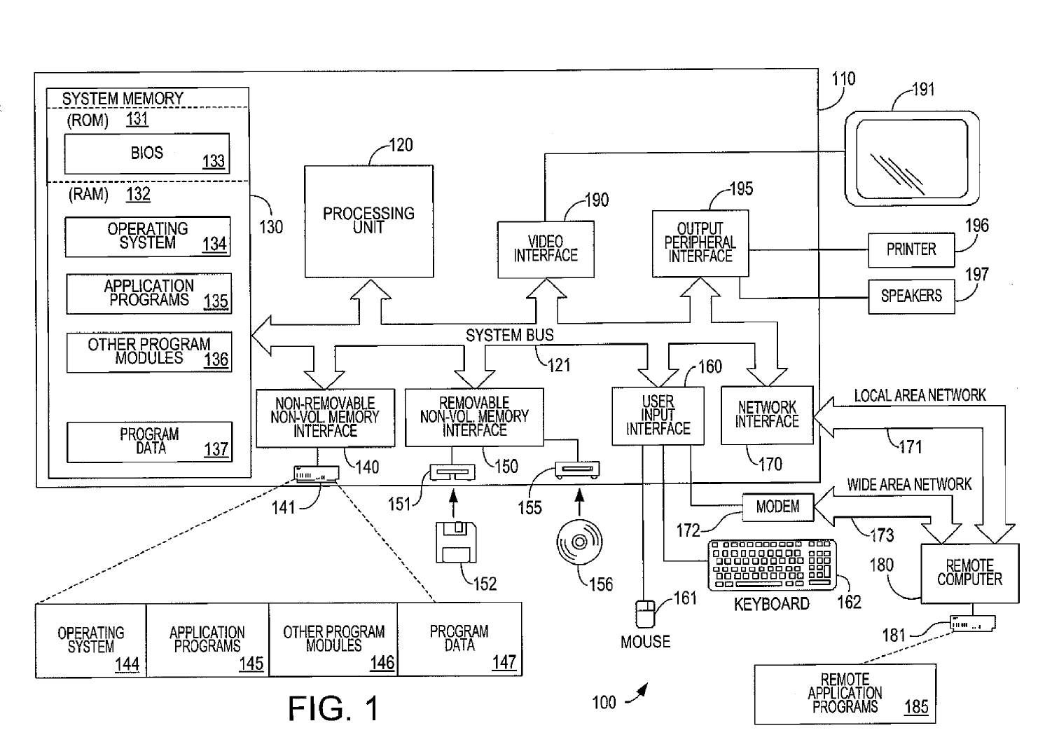

FIG. 1 illustrates an example of a suitable computing system environment 100 that may be used in implementing some embodiments of the invention. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

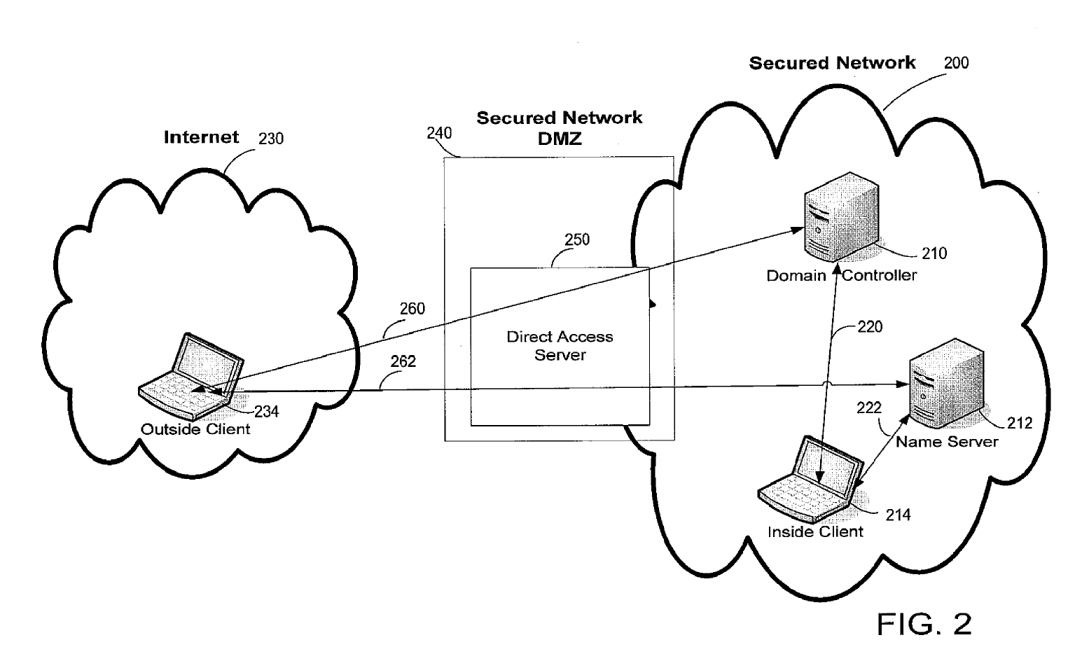

FIG. 2 illustrates a networked computing environment in which the invention may be practiced. The networked computing environment includes a network, which may be a secured network 200, such as a corporate intranet. The secured network 200 may include networked computing devices physically connected to the secured network 200. The physical connection of networked computing devices to the secured network 200 may be made over any suitable computer communications medium (e.g., wired or wireless communication), as the invention is not limited in this respect. One such networked computing device is a computer which may act as a domain controller 210. Domain controllers are known, and domain controller 210 may be implemented using techniques as are known in the art. However, any suitable techniques may be used to construct domain controller 210. One example of a domain controller 210 is a computer such as the computing system 100 running Active Directory on the Windows 2003 Server Operating System.

Another networked computing device may be a computer acting as a name server 212, such as any combination of devices running a DNS service. Name servers are also known in the art, and name server 212 may be implemented using known techniques. However, any suitable techniques may be used for implementing name server 212. As one example of an alternative technique, it is possible that a name service may be implemented on the same computer as domain controller 210.

The secured network may also include a user client computer 214 physically connected to the secured network 200, which may access computing resources in the secured network 200, such as the domain controller 210 and the name server 212. Client computer 214 may be on the premises of a company providing secured network 200. In such a scenario, physical connectivity may be achieved by connecting client 214, either through a wired or wireless connection, to a network access point on the company's premises. However, any suitable mechanism for achieving a physical connection to secured network 200 may be employed.

In the scenario illustrated in FIG. 2, client 214 has authenticated with domain controller 210. Accordingly, client 214 may have access to resources on secured network 200. The user client 214's access to computing resources is illustrated by bi-directional network links, such as the link 220 between the client 214 and the domain controller 210 and the link 222 between the client 214 and the name server 212.

The networked computing environment of FIG. 2 may also include other networks to which secured network 200 is connected. FIG. 2 illustrates as an example, the Internet 230. Remote computing devices, such as a user client computer 234 may be connected to the Internet 230. Here, client computer 234 may be a laptop computing device or other mobile computing device. Accordingly, though clients 234 and 214 are shown as separate devices, remote client 234 may be the same device as client 214, but operated in different locations at different times. For example, client 214 may represent a mobile computer used by an employee of the company operating secured network 200 in the office during the work day. Remote client 234 may be the same mobile computer moved by the employee to the employee's home for use after the work day.

Regardless of the specific hardware used to implement clients 214 and 234, the environment illustrated by FIG. 2 may support multiple devices, any of which may be connected to secured network 200 inside or outside the network firewall. Clients may be connected inside the firewall by a direct connection (whether a wired connection, a wireless connection or connection over any other suitable media) via access points, routers, switches, hubs, secure tunnels or other network elements to other devices on a secured network 200. Clients may be remotely connected to secured network 200 outside the firewall using a remote access mechanism that relies on communications over Internet 230 or other outside network.

The networked computing environment also includes a Demilitarized Zone (DMZ) 240 for the secured network 200, allowing limited network communication between the secured network 200 and the Internet 230. DMZ 240 may include components that block unauthorized traffic, such as a firewall, and other components that allow some traffic to pass. The DMZ 240 may include networked computing devices, such as a computing system acting as a direct access server 250. In the embodiment illustrated, direct access server 250 may be implemented as a router. Clients not physically connected to the secured network 200, such as client computer 234, may connect through the direct access server 250 to communicate without the use of a VPN, with computing resources inside the secured network, such as domain controller 210 and name server 212. The user client 234's access to computing resources in the secured network is illustrated by bi-directional network links passing through the direct access server 250, such as the link 260 between the client 234 and the domain controller 210 and the link 262 between the client 234, and the name server 212. As illustrated, a remote client, such as client 234 may access the same network resources on secured network 200 as a computer, such as client 214, physically connected to secured network 200.

As a result, client 234, like client 214, may authenticate with domain controller 210. If client 234 establishes its security state based on the ability to authenticate with domain controller 210, client 234 may have a different security risk than client 214 that may configure its security state in the same way. While client 214 is separated by DMZ 240 from other devices on Internet 230 that may be used by malicious third parties, client 234 is not. Thus, while client 214 may appropriately use less restrictive security settings because all other devices on secured network 200 are considered trusted, client 234 is exposed to risk from devices connected to Internet 230 if it uses the same less restrictive settings. Thus, in some embodiments, even though client 234 authenticates with domain controller 210, the security states of client 234 may be established based on a determination of its network location that is independent of its ability to authenticate with domain controller 210.

Though settings that establish client security-related actions are used as an example of settings that may be selected based on network location, other types of settings may be similarly selected. For example, if client 234 establishes any other type of setting based on network location, it may function incorrectly or counter to what the user expects without accurate network location determination. Accordingly, techniques described herein may be applied to improve selection of any settings based on network location.

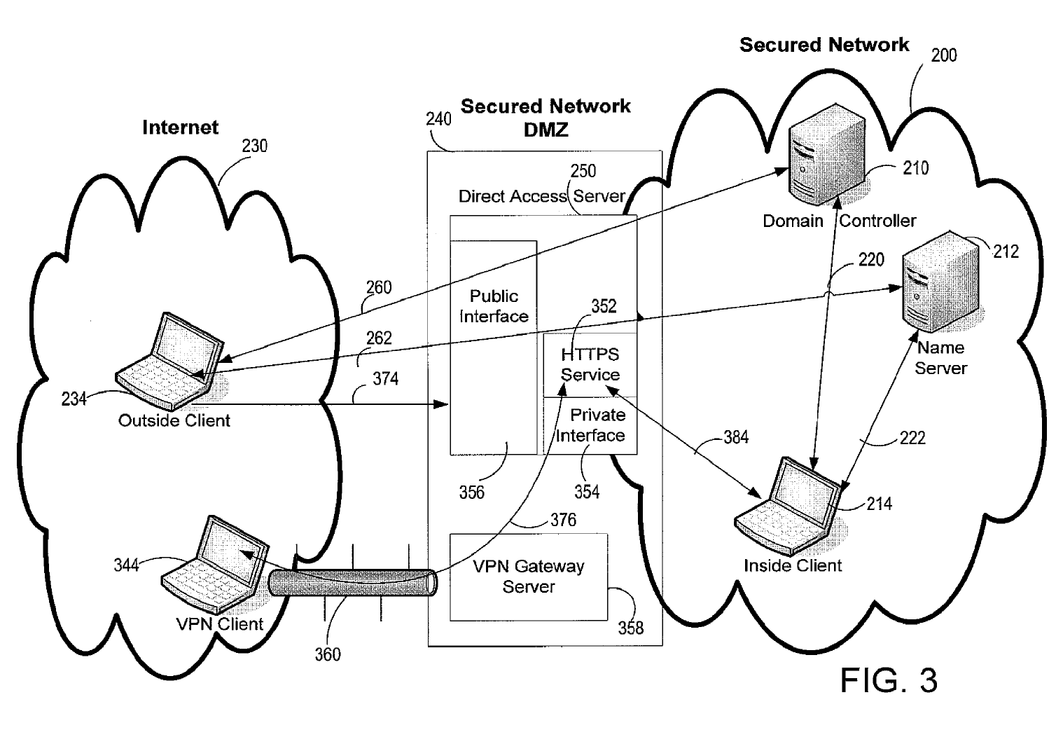

FIG. 3 illustrates a networked computing environment, similar to the environment of FIG. 2. DMZ 240 in FIG. 3 further incorporates a VPN Gateway Server 358. VPN Gateway Server 358 is a computing device which provides the functionality of a VPN gateway as is known in the art. Also pictured is VPN client 344, physically connected to the Internet 230. Like client computer 234, VPN client 344 may be a laptop computing device or other mobile computing device. VPN gateway server 358 allows computers not physically connected to a secured network 200, such as VPN client 344, to establish a virtual connection to the secured network by establishing a secure tunnel 360 between the VPN gateway server 358 and VPN client 344. Once the secure tunnel 360 is established through VPN gateway server 358, VPN client 344 is virtually connected to secured network 200 within the network firewall, comprising a logical portion of secured network 200.

FIG. 3 also incorporates a mechanism to allow computing devices, such as user client 214, user client 234, and VPN client 344, to securely determine whether they are directly connected to secured network 200. The networked computing environment further includes a network service, such as an HTTPS service 352, used for network location awareness, running on a computing device connected to the secured network 200. Examples of implementations of the HTTPS service 352 are the Apache HTTP Server and the Microsoft Internet Information Services. In this embodiment, the HTTPS service 352 is running on the direct access server 250, but it may be running on any computing device connected to the secured network 200. Though HTTPS is used as an example of a secure protocol, it should be appreciated that any service with a secure protocol can be used in an embodiment, HTTPS is just one example.

The direct access server 250 provides two network interfaces: a private interface 354 and a public interface 356. Private interface 354 provides connections between the direct access server 250 and networked computing devices directly connected to the secured network, such as user client 214 and VPN client 344. Public interface 356 provides connections between the direct access server and networked computing devices outside the secured network 200, such as user client 234. In the embodiment illustrated, public interface 356 and private interface 354 are configured such that, for certain requests, a network client will perceive a different response depending on its location. For example, client 214, physically connected to secured network 200, because of the actions of a public interface 356 and private interface 354, will perceive a different response to certain requests than client 234. The interfaces 354 and 356 are configured such that clients communicating through private interface 354 may communicate with HTTPS service 352, but clients communicating through public interface 356 may not communicate with HTTPS service 352. Other network communication between client 234 and other networked computing devices connected to secured network 200 is allowed to pass through public interface 356. Thus, in this embodiment, client 214 and VPN client 344 will receive a reply to a request sent to HTTPS service 352. In contrast, client 234 will receive no reply to a request sent to HTTPS service 352. In this way, the clients can perceive different responses, depending on whether a reply is received.

In FIG. 3, the ability or inability of networked computing devices to communicate with each other is illustrated by unidirectional or bi-directional network links. Bi-directional links passing through the public interface 356 and the direct access server 250 illustrate the ability to communicate with networked computing resources in secured network 200, such as the link 260 between the client 234 and the domain controller 210 and the link 262 between the client 234 and the name server 212. Similarly, the bi-directional link 364 passing through private interface 354 and the direct access server 250 illustrates connectivity between user client 214 and the HTTPS service 352. In like manner, the bi-directional link 376 passing through secure tunnel 360, VPN gateway server 358, direct access server 250, and private interface 354 illustrates the ability to communicate between VPN client 344 and HTTPS service 352. On the other hand, unidirectional link 374 between user client 234 and HTTPS service 352 does not pass through public interface 356, illustrating the inability to communicate through the public interface to the HTTPS service 352.

A client directly connected to the secured network 200 within a network firewall, such as client 214 or VPN client 344, is able to communicate through private interface 354 to the HTTPS service 352, and is therefore able to place a request to the HTTPS server 352 and receive a reply. Based on the reply from HTTPS server 352, client 214 or VPN client 344 is able to determine that it is directly connected to the secured network and set its security policies accordingly. On the other hand, a client not directly connected to the secured network 200, such as client 234, is not able to communicate through public interface 356 to the HTTPS service 352, and is therefore not able to place a request to the HTTPS server 352 or receive a reply. Based on the lack of a reply from HTTPS server 352, client 234 is able to make a determination that it is not directly connected to secured network 200, and can configure its security policies to be more restrictive than it would if it were directly connected to the secured network 200.

In the embodiment of FIG. 3, computing devices such as VPN client 344 which are directly connected to secured network 200 through a virtual connection, but not physically connected to secured network 200, may connect through private interface 354 to communicate with HTTPS service 352. Therefore, in this embodiment, VPN client 344 will receive a reply to a request sent to HTTPS service 352. Other embodiments, however, may treat computing devices which are virtually but not physically connected to secured network 200 differently. For example, in another embodiment, private interface 354 may not allow communication between VPN client 344 and HTTPS service 352. In this case, VPN client 344 would not receive a reply to a request sent to HTTPS service 352, and like client 234, may determine that it configure its security policies to be more restrictive than it would if it were physically connected to the secured network 200. In yet another embodiment, private interface 354 may allow communication between HTTPS service 352 and VPN client 344, but HTTPS service 352 may be configured to provide a different type of response to VPN client 344 than the response it would provide to user client 214. This other type of response would allow VPN client 344 to determine that it should apply a third type of settings, such as security settings more restrictive than that applied by client 214, but less restrictive than that applied by client 234.

Private interface 354 may be implemented using techniques as are known in the art. Public interface 356 may similarly be implemented using known interface techniques. However, public interface 356 may be modified to block communications from a remote client. Any suitable blocking mechanism may be used. For example, public interface 356 may be configured with a filtering component that blocks network packets based on the destination address contained within the packet header. For example, public interface 356 may block all incoming packets that include a destination address for HTTPS service 352. However, other implementations are possible. For example, public interface 356 may block any outgoing packets that contain a source address indicating the packets were generated by HTTPS service 352.

In the embodiment illustrated in FIG. 3, public interface 356 blocks all packets exchanged between a remote client, such as client 234, and HTTPS service 352. Such an implementation may be suitable when HTTPS service 352 performs no functions that remote clients are intended to access. In embodiments when some interactions between remote clients and HTTPS service 352 are intended, the filtering component of public interface 356 may be further configured to filter packets based on the nature of information in the packet. For example, HTTPS service 352 may be configured to provide a response to a request intended specifically to enable a remote client to determine its network location. The filtering component of public interface 356 may be configured to examine portions of a packet identifying the nature of the information contained in the packet. Based on such an examination, the filtering component may block transmission of only packets containing a request or reply intended for use in determining network location.

The network service used for location awareness, such as HTTPS service 352, is secure in order to allow a client of the network service, such as client 214, client 234, or VPN client 344, to verify the identity or security credentials of the service and make a determination whether the client should trust a reply received from the service. For example, in some embodiments, the reply of HTTPS service 352 may include an SSL certificate containing the identity of the HTTPS service, which a client of the service, such as client 214, can verify to determine whether or not to trust the reply from HTTPS service 352. If client 214 determines that a reply from HTTPS service 352 is to be trusted, it can assume that it is physically connected to secured network 200, and implement its security settings accordingly to a less restrictive state. On the other hand, if client 214 is not able to verify the SSL certificate returned by HTTPS service 352, client 214 may deem that it has not received a reply from service 352 and assume it is not directly connected to secured network 200, and implement more restrictive security settings.

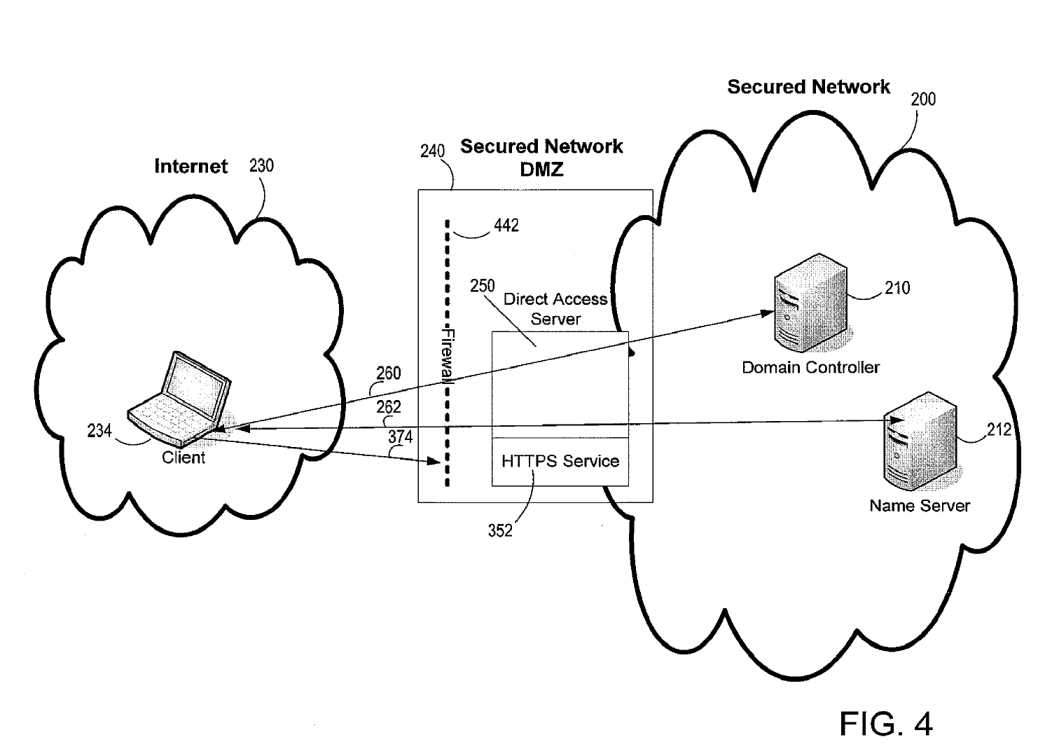

FIG. 4 illustrates a networked computing environment, similar to the environment of FIG. 2, configured according to some other embodiments to support network location determination. In the embodiments of FIG. 4, the DMZ 240 further incorporates a network device that may act as a firewall 442. The firewall 442 analyzes networked communication from devices outside the secured network 200 to computing devices in DMZ 240 or in the secured network 200, and may allow or disallow some such communication. In particular, the firewall 442 may disallow communication from devices outside the secured network, such as client 234, to the HTTPS service 352, but may allow communication from devices outside the secured network, such as client 234, to other networked computing resources inside the secured network, such as domain controller 210 and name server 212. As can be seen by bi-directional links 260 and 262, the firewall 442 allows communication between client 234 and domain controller 210 and between client 234 and name server 212, respectively. On the other hand, unidirectional link 374 from client 234 to HTTPS service 352 is blocked by the firewall 442, and illustrates an inability to connect to the HTTPS service 352. As discussed above in connection with FIG. 3, firewall 442 may block all communication from remote devices to HTTPS service 352. However, in embodiments in which the response to a specific type of request to HTTPS service 352 is used to determine network location, firewall 442 may be configured to block only packets containing such a request.

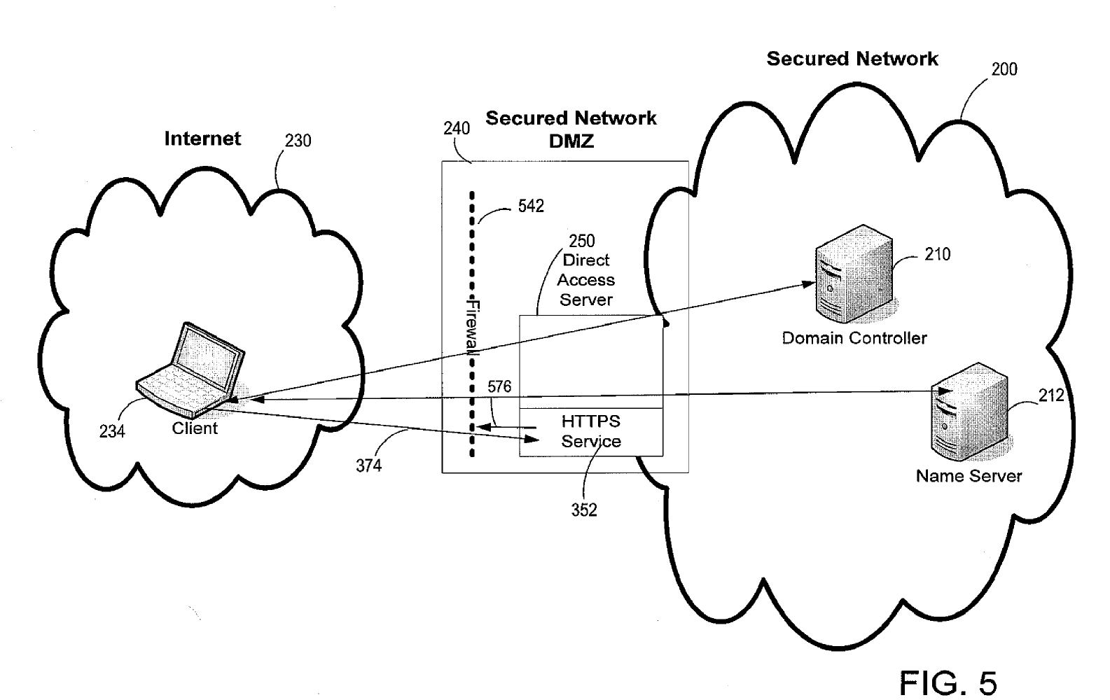

FIG. 5 illustrates an alternative embodiment of the invention, similar to the embodiments illustrated in FIG. 4. In the embodiments of FIG. 5, the DMZ 240 incorporates a networked device that may act as a firewall 542. Similar to firewall 442, firewall 542 analyzes network communication from devices outside the secured network 200 to computing devices in DMZ 240 or in the secured network 200, and may allow or disallow some such communication. Firewall 542, however, may be configured with different security settings than firewall 442. In particular, firewall 542 may allow incoming communication from devices outside the secured network, such as client 234, to the HTTPS service 352, but may disallow or block outgoing communication from the HTTPS service 352 to client 234. As with firewall 442, firewall 542 may allow bi-directional communication between devices outside the secured network 200, such as client 234, and other networked computing resources inside the secured network, such as domain controller 210 and name server 212. As can be seen by bi-directional links 260 and 262, the firewall 542 allows communication between client 234 and domain controller 210 and between client 234 and name server 212, respectively. Unidirectional link 374 from client 234 passes through firewall 542 to reach the HTTPS service 352. Unidirectional link 576 from HTTPS service 352 to client 234, however, is illustrated as being blocked by firewall 542. As discussed in connection with FIG. 4, in embodiments in which the response to a specific type of request to HTTPS service 352 is used to determine network location, firewall 542 may be configured to block only packets containing such a response. The lack of reply from HTTPS service 352 received by client 234 may be used by client 234 to determine that it is not directly connected to the secured network 200.

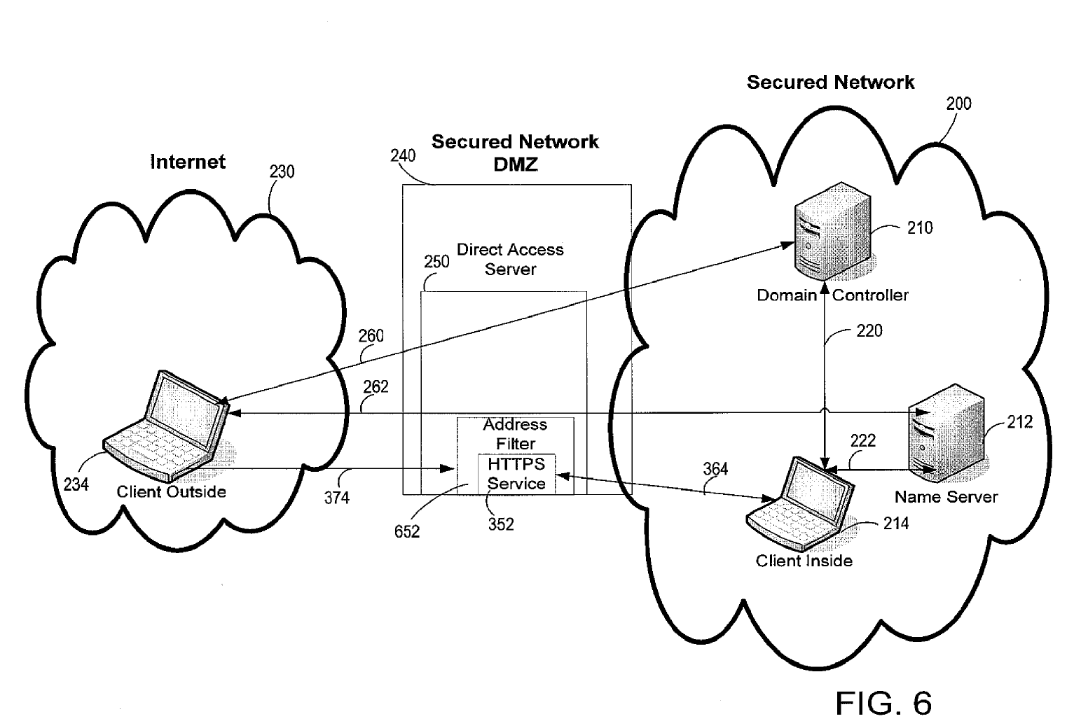

FIG. 6 illustrates a networked computing environment, similar to the environment of FIG. 2, configured according to some alternative embodiments, to support network location determination. The HTTPS service further incorporates a filter, such as a network address filter 652. Similar to what was discussed in FIG. 3 in conjunction with a filtering component of public interface 356, network address filter may be configured to block a request to HTTPS service 352 based on information about the source network address contained within the packet header of such a request. For example, network address filter 652 may examine a portion of the source network address contained within a request to HTTPS service 352 to determine if the source network address is within the network address range of the secured network 200. If the source network address is an IPv6 network address, for instance, the network address filter can check that the source address is within the secured network prefix range.

Though network address is used as an example of a criteria used to determine the nature of a reply, other criteria may be used to determine the nature of a response. For example, the reply could be different, depending on whether the request was received through a public or private interface. Moreover, though issuing a reply and not issuing a reply are used as examples of different responses, these are also only examples of different responses. As another example, different responses may be generated by issuing a reply in all cases, but using a different format for the reply depending on network location. As one example, a reply may indicate the network address or network location of the client. Also, in embodiments described above, the same device generates a reply to requests from clients that are directly or indirectly connected to the network. Such an architecture is not required. For example, requests from directly connected clients may be routed to one device, which issues one type of reply, while requests from clients not directly connected may be routed to another device, which issues a different type of reply.

In the embodiment illustrated in FIG. 6, client 214 is physically connected to secured network 200; accordingly, if IPv6 addressing is used by secured network 200, the network address of client 214 is in the secured network prefix range. Because client 234 is not physically connected to network 200, the network address of client 234 is not in the secured network prefix range. Network address filter 652 may then, upon inspection of their requests, block a request from client 234 to HTTPS service 352 but allow a request from client 214 to HTTPS service 352.

As in previous illustrations, the ability or inability of networked computing devices to communicate with each other is illustrated by unidirectional or bi-directional network links. Bi-directional links passing through the direct access server 250 display the ability to communicate with networked computing resources in secured network 200, such as the link 260 between the client 234 and the domain controller 210 and the link 262 between the client 234 and the name server 212. Similarly, the bi-directional link 364 passing through network address filter 652 and the direct access server 250 illustrates connectivity between user client 214 and the HTTPS service 352. On the other hand, unidirectional link 374 between user client 234 and HTTPS service 352 does not pass through network address filter 652, illustrating the action taken by network address filter 652 to block a request from client 234 to the HTTPS service 352.

In this embodiment, as also discussed above in previous embodiments, the lack of a reply from the HTTPS service 352 may allow the requester, such as client 234, to make a determination that it is not directly connected to secured network 200, and to set its security settings accordingly to a more restrictive state.

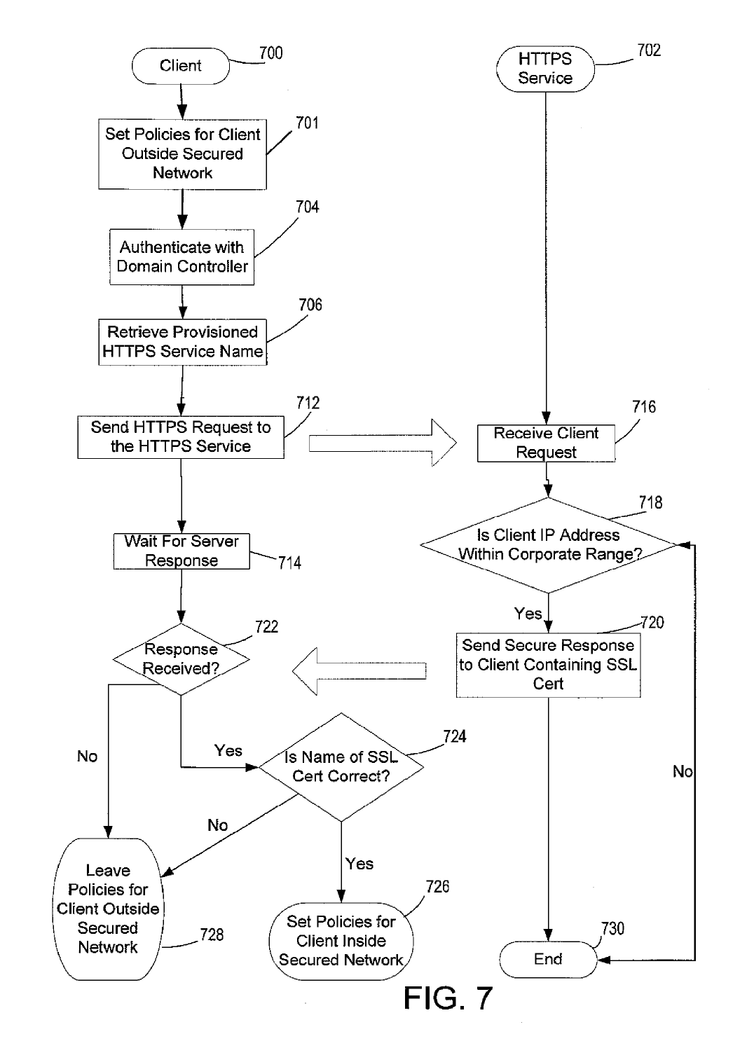

FIG. 7 illustrates a flow chart of a method of operation of a network client 700, such as the previous embodiments of clients 214 or 234, and a network device configured to perform network location determination, such as a device running an HTTPS service 702, such as HTTPS service 352 in previously discussed embodiments.

Initially, client 700 does not know its network location and at block 701 may apply default settings appropriate for a client not directly connected to a secured network. With security policies, for example, the client applies a setting appropriate for the least secure location in which it may operate.

In step 704, client 700 may authenticate itself with a domain controller, such as domain controller 210. This may be done by connecting through a direct access server, such as direct access server 250, or directly, if the client is physically connected or virtually connected, such as via a VPN, to a secured network, such as secured network 200.

In step 706, client 700 retrieves the name of the HTTPS service 702 which has been provisioned to the client. For example, client 700 may have previously been provisioned with a name of the HTTPS service 702 at a time when it was physically connected to a secured network, such as secured network 200. At that time, the provisioned name may have been stored locally on a computer storage medium on the client to be retrieved later, as in step 706.

The client 700, in step 712, issues an HTTPS request to HTTPS service 702. In step 714, client 700 waits a predetermined time interval for a reply from HTTPS service 700.

If the request from client 700 was not blocked from reaching HTTPS service 702 by means of one of the mechanisms described above, HTTPS service 702 receives the client request in step 716. In step 718, a filter, such as network address filter 652, inspects a portion of the network address of the client to determine whether the network address of the client is in the range of the secured network, such as secured network 200. If the network address is not in the secured network range, the process of FIG. 7 branches from step 718 to end block 730 and the client does not receive a reply from HTTPS service 702. If, on the other hand, the network address of client 700 is in the secured network range, HTTPS service 702 may respond to the client 700, in step 720, which may be a secure response, containing an SSL certificate. In either case, at this point, the HTTPS service 702 has finished processing the request of the client 700, and proceeds to the end block 730.

Though, it should be appreciated that in some embodiments it may be desirable for HTTPS service 702 to respond, regardless of network location of the client issuing a request, but to respond with a different type or response depending on the location of the client. In such embodiments, the wait time at step 714 may be reduced if a response is generated regardless of location of the client.

The process of FIG. 7 branches at step 722 depending on whether the client has received any response from HTTPS service 702 within the predetermined time interval. If client 700 has not received a reply, as may be the case if either its request or reply was blocked by means of one of the embodiments illustrated in FIGS. 3-6, client 700 proceeds to step 728, in which it makes the determination that it is not physically connected to the secured network, such as secured network 200, and accordingly leaves its settings in their default state. For example, security policies remain set to a more restrictive state.

If client 700 did receive a response from HTTPS service 702, it then verifies in step 724 the identity or security credentials of the HTTPS service 702, such as an SSL certificate. If the client 700 cannot successfully verify the SSL certificate received from HTTPS service 702, the client 700 proceeds to step 728, and as described above, makes the determination that it is not physically connected to the secured network, such as secured network 200. The client sets its policies accordingly, for example, setting its security policies to a more restrictive state.

If the client 700 successfully verifies the SSL certificate received from HTTPS service 702, it proceeds to step 726. At this point, the client may determine that it is physically connected to the secured network, such as secured network 200. The client sets its policies accordingly, for example, setting its security policies to a less restrictive state.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that performs particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of operating a client device (214, 234) when connected to a network (200) comprising a network firewall defining a network boundary, the client device (214, 234) supporting at least a first (726) and a second (728) behaviors, the method comprising:
directing (712) a request to a network device (352), the network device (352) being connected to the network (200) and being adapted to provide at least a first response (720) or second response (730), different than the first response (720), to the request, the first response being provided when the request is received from a client device (214) within the network firewall connected to the network (200), and the second response (730) being provided when the request is received from a client device (234) connected to the network (200) outside the network firewall;
when the first response is detected, configuring the client device (214) to operate in accordance with the first behavior (726); and
when the second response is detected, configuring the client device (214) to operate in accordance with the second behavior (728).

2. The method of claim 1, wherein:
the first response is detected when the client device (214) receives information authenticating the network device (352); and
the second response is detected when the client device (234) does not receive information authenticating the network device (352) during an interval.

3. The method of claim 2, further comprising, on the network device (352):
receiving (716) the request from the client device (214), the request comprising an address of the client device (214);
when the address of the client device (214) identifies a location physically on the network (200) or a location connected to the network through a VPN, responding with the first response; and
when the address of the client device (214) identifies a location not within the network firewall, responding with the second response.

4. The method of claim 2, further comprising, on the network device (352):
receiving (716) the request from the client device (214), the request comprising an address of the client device (214);
when the address of the client device (214) identifies a location physically on the network (200), responding with the first response; and
when the address of the client (214) device identifies a location not physically on the network (200) or a location connected to the network through a VPN, responding with the second response.

5. The method of claim 2, wherein the network device (352) comprises a first network device (352) and the network (200) comprises a second network device (442, 652), the method further comprising:
on the second network device:
receiving the request from the client device (214), the request comprising an address of the client device (214);
when the address of the client device identifies a location physically or virtually on the network (200), providing the request to the first network device (352); and
when the address of the client device (234) identifies a location not within the network firewall, blocking the request from reaching the first network device (352).

6. The method of claim 3, wherein the network device (352) comprises a first network device (352) and the network (200) comprises a second network device (542), the method further comprising:
on the second network device (542):
receiving from the first network device (352) a response to the request, the response comprising an address of the client device (214);
when the address of the client device (214) identifies a location physically on the network (200), providing the response to the client device (214); and
when the address of the client device (214) identifies a location not physically on the network (200), blocking the response from reaching the client device (214).

7. The method of claim 1, wherein the network (200) comprises a corporate network (200) having a corporate address prefix, and the method further comprises:
making the first response when the request is identified by a source address including the corporate address prefix; and
making the second response when the request is identified by a source address that does not have the corporate address prefix.

8. The method of claim 7, wherein the configuring the client device (214, 234) to operate in accordance with the first behavior (726) comprises configuring a firewall with a less restrictive policy than when the client device (214, 234) is configured to operate in accordance with the second behavior (728).

9. A client device 214 adapted for being connected to a network (200), the client device (214) comprising:
a computer storage medium comprising:
a component that affects operations on the client device (214), the component operable in at least a first state and a second state;
computer-executable instructions that, when executed, perform a method comprising:
directing (712) a request to a network device (352), the request comprising a source address, including a source address portion, the network device (352) being adapted to provide at least a first response and a second response (730), the first response (720) to the request being provided when the source address portion matches a network address portion identifying the network and the second response (730) to the request being provided when the source address portion does not match the network address portion;
when the first response is detected, configuring the component to operate in the first state (726); and
when the second response is detected, configuring the component to operate in the second state (728).

10. The client device (214) of claim 9, wherein the component comprises a firewall.

11. The client device (214) of claim 9, wherein the computer storage medium further comprises a field adapted to store an identification of the network device (352).

12. The client device (214) of claim 11, wherein:
the computer storage medium further comprises at least one field adapted to store authentication information for the network device (352); and
the method performed by the computer executable instructions further comprises ascertaining (724) whether a response is the first response by attempting to authenticate that the response was generated by the network device (352) using the authentication information.

13. The client device (214, 234) of claim 9, wherein the network device (352) comprises a server (250) and the first response comprises an HTTPS page.

14. The client device (214, 234) of claim 9,
further comprising a timing component adapted to indicate a time after the request is sent, and
wherein:
the method performed by the computer executable instructions further comprises detecting (722) the second response (730) when the first response (720) is not received with the time after the request is sent.

15. The client device (214, 234) of claim 9, further comprising a component for accessing a corporate network 200 when the client device is directly connected to the network and when the client device is indirectly connected to the network.

16. A system comprising,
a network (200);
an access device (250) having at least one internal interface (354) and at least one external interface (356), the at least one internal interface being connected to devices within the network, and the at least one external interface being connected to remote devices, the access device adapted to couple network communications between the at least one internal interface and the at least one external interface;
at least one network device (352) coupled to the network, the at least one network device being configured to make a first response (720) to a request received through the at least one internal interface and to make a second response (730) to a request from a device received through the at least one external interface; and
a client device (234) coupled to the network through the at least one external interface, the client device being configured to:
issue (712) the request;
when the first response is received, operate in a first mode (726); and
when the second response is received, operate in a second mode (728).

17. The system of claim 16, wherein:
the client device coupled to the network through the at least one external interface comprises a first client device;
and the system further comprising:
a second client device (214) coupled to the network through the at least one internal interface, the second client device being configured to:
issue (712) the request;
when the first response is received, operate in a first mode (726); and
when the second response is received, operate in a second mode (728),
wherein the second client device is operating in the first mode.

18. The system of claim 16, wherein the client device (234) is a portable computer.

19. The system of claim 16, wherein the client device 234 further comprises a network firewall adapted to operate in the first security mode and in the second security mode and the first mode comprises the firewall operating in the first security mode and the second mode comprises the firewall operating in the second security mode.

20. The system of claim 16, wherein the client device is configured to connect to the network through the access device.
